(19) United States
(12) Patent Application Publication
(10) Pub. No.: US 2006/0218796 A1
(43) Pub. Date: Oct. 5, 2006

(54) Cutter Bar of a Motor-Operated Hedge Trimmer

(75) Inventor: Georg Heinzelmann, Backnang (DE)

Correspondence Address: GUDRUN E. HUCKETT DRAUDT, LONSSTR. 53, WUPPERTAL, 42289, DE

(73) Assignee: ANDREAS STIHL AG & CO. KG, Waiblingen (DE)

(21) Appl. No.: 11/308,253

(22) Filed: Mar. 14, 2006

(30) Foreign Application Priority Data
Mar. 31, 2005 (DE) 102005014576.0

(51) Int. Cl. B26B 7/00

(52) U.S. Cl. 30/276

(57) ABSTRACT

A cutter bar of a motor-operated hedge trimmer has a blade support and at least one cutter blade guided so as to slide oscillatingly on the blade support. The cutter blade has laterally projecting cutting teeth defining a blade plane. A cutter guard is mounted on the blade support and extends across at least a part of the cutter blade. The cutter guard has laterally projecting guard fingers covering the cutting teeth with oversize. The cutter guard is made of an impact-resistant plastic material. The cutter guard has a longitudinal support extending in a longitudinal direction of the blade support. The guard fingers are attached to the longitudinal support. The guard fingers are more bending resistant than the longitudinal support in a deformation plane that is perpendicular to the blade plane and to the longitudinal direction.

### BACKGROUND OF THE INVENTION

The invention relates to a motor-operated hedge trimmer comprising a blade support, at least one cutter blade slidingly guided in an oscillating way on the blade support and provided with laterally projecting cutting teeth defining a blade plane, and a cutter guard mounted on the blade support and extending across at least a part of the cutter blade and having laterally projecting guard fingers covering the cutting teeth with oversize.

Hedge trimmers comprising a drive motor in the form of an internal combustion engine or an electric motor have a cutter bar for cutting off branches of a hedge or the like. The cutter bar comprises a supporting blade support fixedly connected to the trimmer on which at least one cutter blade is guided so as to be slidable in an oscillating way. The cutter blade has laterally projecting cutting teeth that define a blade plane and is reciprocated by the drive motor in the longitudinal direction of the cutter bar. Additional cutting teeth are provided either stationarily on the blade support or on an additional cutter blade moving in the opposite direction. Branches that are introduced laterally between the cutting teeth are cut by the oppositely moving cutter blades.

In the prior art configurations the cutter bar also comprises a cutter guard that extends at least across a part of the cutter blade proximal to the motor and is arranged stationarily and fixedly on the blade support. The cutter guard has laterally projecting guard fingers that are arranged parallel to the blade plane. The guard fingers are longer than the cutting teeth in the lateral direction and cover therefore the movement area of the cutting teeth with excess length. For increasing the operational safety and for fulfilling relevant approval regulations, the guard fingers are dimensioned with regard to length and spacing such that only objects below a predetermined maximum cross-sectional size can be introduced between the guard fingers and can thus be brought into the cutting area of the cutter blades.

For a proper handling of the hedge trimmer a minimal total weight particularly in the area of the cutter bar is desirable. Taking into consideration lightweight construction requirements, embodiments of the aforementioned cutter guard—whose design required a compromise between mass and mechanical roadability—are known that are made of aluminum. In practical use, occasional excess loading by hitting thicker branches or the like and/or by improper handling cannot be prevented. It was found that the aluminum guard fingers have the tendency to bend. In particular when immersing the cutter bar into a hedge, the guard fingers can be bent away from the blade plane in the upward direction so that their protective effect is lost. In the opposite bending direction, i.e., bending into the blade plane, a collision with the moving cutting blade occurs; this can lead to an overload and damage of the arrangement.

### SUMMARY OF THE INVENTION

It is an object of the present invention to further develop a cutter bar of the aforementioned kind such that the operational safety is increased.

This object is solved according to the present invention by a cutter bar that is manufactured of an impact-resistant plastic material.

An embodiment of the cutter bar of impact-resistant plastic material is proposed; surprisingly, it was found that in such embodiment with an appropriate configuration the guard fingers do not bend or break but instead elastically deflect under a corresponding load in order to subsequently return into their initial position and maintain their protective function. The embodiment according to the invention is based on the recognition that, instead of a reinforced, stiffened and thus heavier construction, an elastic deformation can be deliberately accepted by using impact-resistant plastic material. Impact loads of the guard fingers are absorbed without impairing the protective function. While providing a significant weight reduction that improves the handling of the hedge trimmer, the stress level of the arrangement is significantly lowered.

In an advantageous further embodiment, the guard fingers are fastened to a longitudinal support of the cutter guard that extends in the longitudinal direction of the blade support and is particularly formed as a monolithic part of the cutter guard, wherein the guard fingers are more bending resistant than the longitudinal support in a deformation plane that is perpendicular to the blade plane and to the longitudinal direction. Loads acting on the guard fingers and leading to a bending deformation out of the blade plane cause only to a limited extent bending loads on the comparatively stiff fingers. The elastic resilience is effected instead primarily in the area of the softer longitudinal support. In this area, the occurring stress loads are distributed across a greater longitudinal section so that a correspondingly reduced material loading results. Local overloads of individual guard fingers are thus reliably prevented.

In an expedient embodiment, the longitudinal support has an approximately U-shaped cross-section with two lateral flanks and an interposed flexible support back. For a bending load acting transversely to a cutting plane, a widening or narrowing deformation of the U-shaped cross-section is effected in that the support back elastically curves in the corresponding way. The guard fingers adjoining the lateral flanks transmit their bending load onto the support back in which the occurring loads are distributed uniformly. A compact and lightweight configuration is possible while avoiding stress peaks.

Preferably, the U-shaped cross-section of the longitudinal support encloses a support bar of the blade support wherein the cutter guard is connected with its support back to the support bar and wherein the lateral flanks of the longitudinal support are designed for loosely contacting the support bar. The expediently central attachment of the support back on the support bar allows for a free bending deformation of the support back relative to its cross-section wherein the loose lateral flanks can spread freely and without any impairment of the provided elastic deformation. For a bending load in the opposite direction in which the guard fingers are loaded in the direction toward the blade plane, the two lateral flanks come to rest against the support bar. The elastic deformation in the direction toward the blade plane is limited by forming a stop. A collision of the guard fingers with the moving cutter blades is prevented. For adjusting the elastic deformability in the direction of the blade plane a play between the lateral flanks and the support bar can be provided also. The constructively provided play enables a limited deformation travel with soft characteristic line of bending. After overcoming the play, the lateral flanks rest against the support bar so that a further deformation of the U-shaped cross-section in this direction is impaired and, in this way, a sudden stiffness increase is created while a further bending deformation is avoided.

In a preferred embodiment, the guard fingers, starting at the finger bases, have an increasing spacing relative to the blade plane in the direction toward their fingertips. In this way, an outwardly widening free space between the guard fingers and the cutter blades is formed that enables a limited elastic resilience of the guard fingers in the direction of the cutter blades without causing a collision. By utilizing this free space, the cutter guard can have a corresponding residual resilience that contributes to the prevention of overloads.

In a preferred embodiment, the guard fingers, starting at the fingertips, have an increasing height in the deformation plane. Bending loads that act in the deformation plane cause a uniform stress distribution and thus provide a high load capacity at minimal weight.

In the area of their finger bases adjoining the longitudinal support, the height of the guard fingers matches expediently the height of the longitudinal support itself. The guard fingers are thus supported across their entire inwardly positioned height on the longitudinal support. No parts project upwardly. In this way, a compact flat configuration results that prevents catching on branches and simplifies operation.

Within the blade plane, the guard fingers have expediently a width that increases starting at their fingertips. Under bending loads parallel to the blade plane, there also results a uniform stress level that avoids local stress peaks.

In a preferred further embodiment, the guard fingers have reinforcement ribs that adjoin expediently the longitudinal support or are connected thereto. An effective and highly loadable force introduction from the guard fingers into the longitudinal support results at minimal total weight. Preferably, the reinforcement ribs widen like a fan particularly beginning at the fingertips in the direction toward the finger bases. The occurring loads are therefore introduced in a uniform distribution across a wide base into the longitudinal support. This effect can be expediently further enhanced in that two neighboring guard fingers are connected to one another by at least one common, in particular arc-shaped, reinforcement rib. Neighboring guard fingers form, at least approximately, an elastomechanical unit that contributes to a more uniform distribution of the stress progression.

The reinforcement ribs are preferably arranged on the side of the guard fingers facing away from the cutter blade. Catching or jamming of twigs between the cutter guard and the cutter blade is prevented.

In an advantageous further embodiment, penetrating, in particular grommet-shaped, metal inserts for receiving fasting means are provided in the cutter guard and in particular in its support back. Such fasting means can be screws, rivets, snap fit closures or the like. The metal inserts prevent local creeping of the plastic material. The heat generated during operation by the cutter blade is effectively dissipated so that a thermal overload of the plastic material is prevented.

In a preferred embodiment, a spacing between two neighboring guard fingers is greater than a spacing between two neighboring cutting teeth and is particularly approximately 1.5 times greater. In combination with the elastic resilience of the plastic cutter guard, a reduced resistance is observed on the cutter bar upon immersion into the hedge to be cut.

The cutter guard, in particular its longitudinal support, has advantageously at its free end a slant that ascends beginning at the support bar. It serves as a threading aid for a transport guard to be pushed onto the cutter bar. A wall of such a tubular transport guard is lifted when pushed onto the slant and is guided almost without any resistance across the cutter guard.

### BRIEF DESCRIPTION OF THE DRAWINGS

Embodiments of the invention will be explained in more detail with the aid of the drawing.

FIG. 1 shows a perspective illustration of the hedge trimmer with a plastic cutter guard on the cutter bar.

FIG. 2 is a plan view of the hedge trimmer according to FIG. 1 with details regarding the spacing of the cutting teeth and the guard fingers.

FIG. 3 is a perspective detail illustration of the plastic cutter guard according to FIGS. 1 and 2.

FIG. 4 shows in a plan view an enlarged detail illustration of the cutter guard according to FIG. 3 with details in regard to the ribbed configuration of the guard fingers.

FIG. 5 is a cross-sectional illustration of the cutter bar according to FIGS. 1 and 2 with a U-shaped cross-section of its longitudinal support and with lateral slantedly ascending guard fingers.

FIG. 6 is a variant of the arrangement according to FIG. 5 with a lateral play between the lateral flanks of the longitudinal support and the support bar enclosed by them.

### DESCRIPTION OF PREFERRED EMBODIMENTS

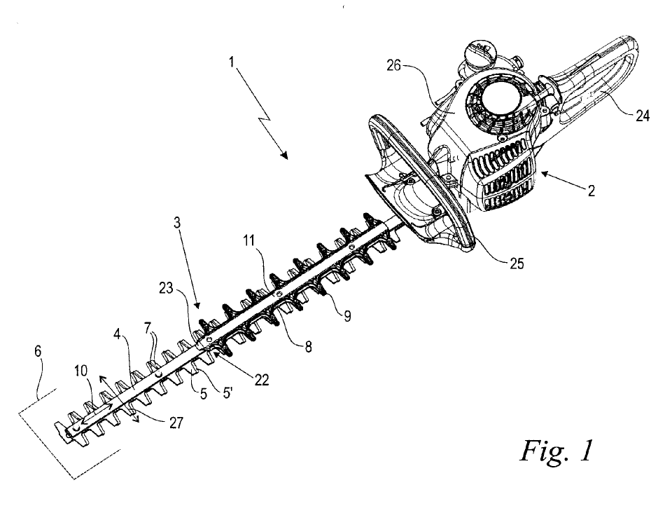

The hedge trimmer 1 according to FIG. 1 comprises a motor part with a motor housing 26 in which a motor 2, not illustrated in detail, in the form of an internal combustion engine is arranged for driving the hedge trimmer 1. It is also possible to provide an electric motor. A cutter bar 3 is connected to the motor part and is driven by the motor 2 in operation. For guiding the hedge trimmer 1, a bow-shaped handle 25 is arranged on the side of the motor part facing the cutter bar 3 and a second handle 24 is arranged on the opposite rear side.

The cutter bar 3 extends in a longitudinal direction 10 and comprises a blade support 4 fixedly and rigidly connected to the motor part. On the blade support 4 two cutter blades 5, 5′, drivable in opposite directions, are guided slidably in the longitudinal direction 10 wherein the cutter blades, driven by the motor 2, carry out opposite oscillating movements in the longitudinal direction 10. The cutter blades 5, 5′ have on both sides laterally projecting cutting teeth 7 that define a blade plane 6. Because of the opposite movement of the cutting teeth 7 occurring in the longitudinal direction 10, twigs that are introduced into the intermediate spaces between the cutting teeth 7 are cut off. An embodiment may be expedient in which only a single movable cutter blade 5 is provided wherein corresponding counter cutting teeth are arranged on the fixed blade support 4.

In the longitudinal area adjoining the front handle 25, the cutter bar 3 is provided with a cutter guard 8 that is comprised of a central longitudinal support 11 extending in the longitudinal direction 10 and guard fingers 9 projecting from both sides. An arrangement may be advantageous in which the cutter guard 8 extends across the entire length of the cutter bar 3. The cutter guard 8 with its longitudinal support 11 and the guard fingers 9 is manufactured as a monolithic part of impact-resistant plastic material and is fixedly connected to, i.e., is immobile on, the blade support 4. On its free end 22 that is facing away from the handle 25, the longitudinal support 11 is provided with a slant 23 that, starting at the surface of the blade support 4, ascends in the longitudinal direction 10 and therefore provides a threading aid for a transport guard that can be pushed onto the cutter bar 3, if needed.

The guard fingers 9 are positioned at a minimal spacing parallel to and above the blade plane 6 so that the oscillating movement of the cutting teeth 7 can be carried without impairment at a minimal spacing below the guard fingers 9.

The cutting teeth 7 and the guard fingers 9 extend in a lateral direction 27 that extends transversely to the longitudinal direction 10 wherein the longitudinal direction 10 and the lateral direction 27 define the position of the blade plane 6.

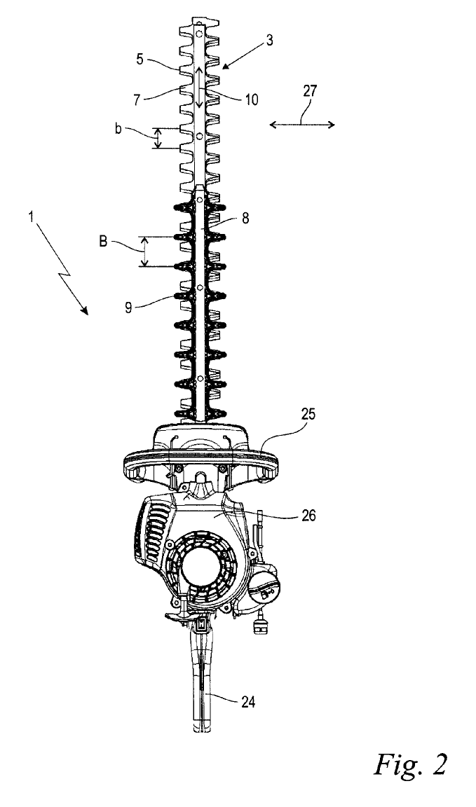

FIG. 2 shows the hedge trimmer 1 according to FIG. 1 in a plan view. It can be clearly seen that neighboring cutting teeth 7 of one side of the cutter blade 5, respectively, have a uniform spacing b relative to one another in the longitudinal direction 10. The cutting teeth 7 that are oppositely positioned in the lateral direction 27 are staggered relative to one another such that, for the same spacing b, a cutting tooth is positioned at the level of a gap between two neighboring cutting teeth 7 on the opposite side. The guard fingers 9 of the cutter guard 8 are arranged symmetrically on both sides and have a constant spacing B relative to one another, respectively, in the longitudinal direction 10 that is greater than the spacing b between two neighboring cutting teeth 7. In the illustrated embodiment, the spacing B between two neighboring guard fingers 9 is approximately 1.5 times the spacing b between two neighboring cutting teeth 7. It can also be expedient to provide a deviating ratio. In particular, the spacings B, b can also be identical.

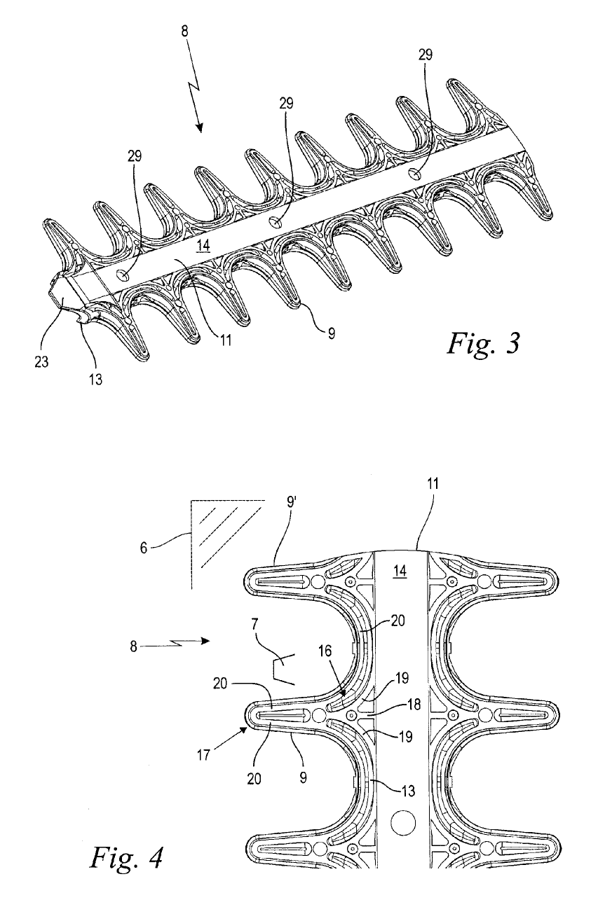

In the lateral direction 27, the guard fingers 9 are longer than the cutting teeth 7 and have in this direction such an oversize that they completely cover the movement area of the cutting teeth 7 in the longitudinal direction 10. The length of the guard fingers 9 and their spacing B relative to one another are matched to one another in such a way that the material to be cut can be fed in the prescribed thickness into the area between the guard fingers 9 and also between the cutting teeth 7 while objects above a predetermined limit diameter rest against two neighboring guard fingers 9 without reaching the cutting area of the cutting teeth 7. The perspective illustration of the cutter guard 8 according to FIG. 3 shows that the guard fingers 9 are formed as monolithic parts of the longitudinal support 11 and together with it form a single injection-molded part. It can be seen that in the area of the slant 23 the longitudinal support 11 has a downwardly open approximately U-shaped cross-section that is constant across the entire length of the cutter guard 8. The U-shaped cross-section is comprised of an upper support back 14 that extends transversely and in the longitudinal direction; lateral flanks 13 that are angled laterally downwardly adjoin the support back. A number of holes 29 that serve for attachment of the cutter guard 8 on the blade support 4 (FIG. 1) are formed in the support back 14.

FIG. 4 shows a detail illustration of the cutter guard 8 according to FIG. 3 in plan view. In the mounted state, the guard fingers 9, 9′ are positioned above the blade plane 6 that is schematically indicated by a cutting tooth 7. On its side visible here and facing away from the blade plane 6 or the cutting teeth 7, the guard fingers 9 are provided with a number of reinforcement ribs 18, 19, 20 that all pass into the lateral flanks 13 of the longitudinal support 11 and effect a mechanical intimate connection of the guard fingers 9, 9′ and the longitudinal support 11.

The illustrated plan view also shows that the guard fingers 9, 9′, relative to the blade plane 6, have in the direction of the longitudinal carrier 11, starting at their fingertips 17, an increasing width that follows a curved contour and has a progressive course in the direction of the finger bases 16 adjoining the longitudinal support 11. A continuous reinforcement rib 20 follows the arc-shaped contour; it starts at a fingertip 17, runs along the finger base 16 and the lateral flank 13, respectively, and thus creates a mechanical connection between neighboring guard fingers 9, 9′. In addition to the reinforcement ribs 20 starting at the fingertips 17 additional reinforcement ribs 18, 19 are provided that start at the central area of the guard finger 9, respectively, and extend in the direction of the longitudinal support 11. In this connection, the reinforcement ribs 18, 19, 20 widen like a fan in the direction of the finger bases 16.

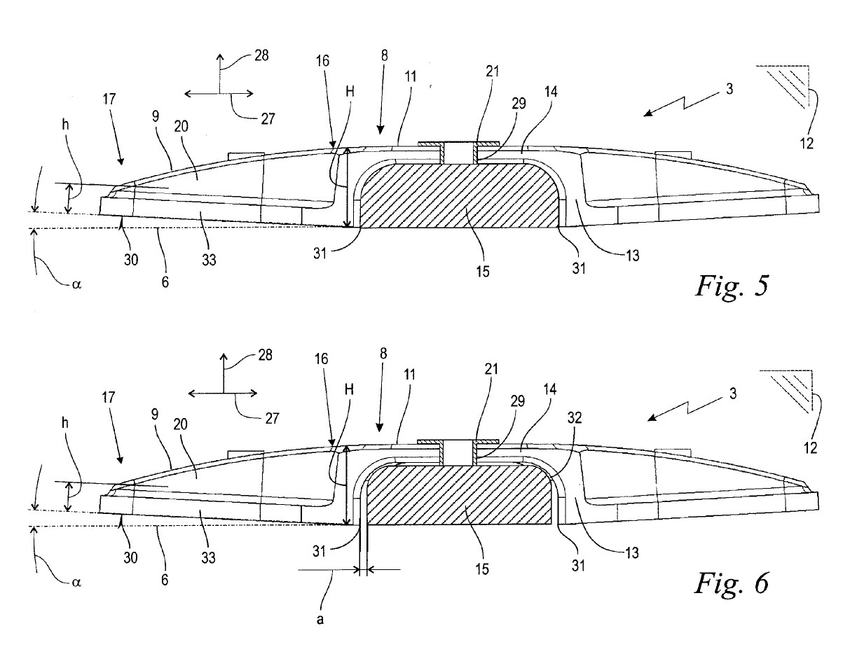

FIG. 5 shows a cross-section illustration of the cutter bar 3 according to FIGS. 1 and 2 illustrating that the blade support 4 (FIG. 1) is configured as a solid metal support bar 15 having a rectangular cross-section rounded at one side. The longitudinal support 11 has an approximately U-shaped cross-section that is downwardly open in the direction toward the blade plane 6 and is formed by two opposed lateral flanks 13 and an upper interposed support back 14. The U-shaped cross-section of the longitudinal support 11 encloses the three sides of the support bar 15 facing away from the blade plane 6 wherein the support back 14 and the lateral flanks 13 rest flat against the support bar 15. Grommet-shaped metal inserts 21 are inserted into the holes 29 of the support back 14 and have on the outer side of the support back 14 a flat collar and centrally a tubular sleeve. Fastening means, for example, in the form of screws, rivets, snap fit connectors, or the like, can be inserted through the holes 29 or the metal inserts 21 for fastening the cutter guard 8 on the support bar 15. The longitudinal support 11 rests flat and loosely on the support bar 15 in the additional areas of the support back 14 and in particular on the lateral flanks 13.

Perpendicular to the lateral direction 27 and to the longitudinal direction 10 (FIG. 1), a vertical direction 28 is provided that is indicated by arrow 28; it defines together with the lateral direction 27 a deformation plane 12. The deformation plane 12, in turn, is positioned perpendicularly to the blade plane 6 and to the longitudinal direction 10 (FIG. 1). The cross-section of the protective cutter guard 8 is designed such that the guard fingers 9 are more bending resistant in the deformation plane 12 than the longitudinal support 11, i.e., in the case of a bending load in the vertical direction 28. For this purpose, the guard fingers 9 are comprised of a flat plate 33 having a side facing away from the blade plane 6 and provided with a upright ribs of which only the reinforcement ribs 20 are shown in the illustrated section view. The additional ribs 18, 19 illustrated in FIG. 4 are attached or formed as monolithic parts in the same way on the flat plate 33 and are supported on the lateral flanks 13 of the longitudinal support 11.

The plate 33 has a substantially constant thickness while the height of the ribs starting at the fingertips 17 increases in the direction toward the finger bases 16. As a whole, the guard fingers 9 have, starting at their fingertips 17, an increasing height in the deformation plane 12 wherein the height h at the fingertips 17 is less than the height H at the finger bases 16. The height H at the finger bases 16 corresponds to the height of the longitudinal support 11 wherein a convexly curved upper edge of the guard fingers 9 has a flowing transition into the external surface of the support back 14. In comparison to the inner height H, the thickness of the support back 14 is significantly smaller so that its bending resistance or curvature stiffness in the deformation plane 12 is significantly smaller than the corresponding bending resistance of the guard finger 9. When a bending load acts on the guard fingers 9 in the vertical direction 28, the support back 14 curves concavely starting at its attachment at the hole 29 so that its U-shaped cross-section is spread. Edges 31 of the lateral flanks 13 and the neighboring area of the support back 14 lift off the support bar 15.

In the case of a bending load in the opposite direction, the edges 31 rest against the support bar 15 so that the supporting action of the guard fingers 9 becomes more bending resistant. A residual elasticity remains within the guard fingers themselves and enables a limited elastic deformation in a direction opposite to the vertical direction 28. A plane bottom side 30 of the guard fingers 9 is slantedly positioned at an angle α relative to the blade plane 6 in such a way that the guard fingers 9, beginning at their finger bases 16, have an increasing spacing relative to the blade plane 6 in the direction toward the fingertips 17. This spacing can be used up in the case of a bending load opposite to the vertical direction 28 without the guard fingers 9 overlapping the blade plane 6. A stepped spacing or a constant spacing in the lateral direction 27 between the bottom side 30 and the blade plane 6 can also be expedient.

According to FIG. 6, an expedient variant is provided in which between the lateral flanks 13 and the support bar 15 a lateral play a is provided. Inner spacers 32 of the longitudinal support 11 effect in the unloaded state this spacing a as well as a spacing between the support back 14 and the support bar 15 in the vertical direction 28. The metal insert 21 is correspondingly longer and rests against the support bar 15 so that a thermal insulation between the support back 14 and the support bar 15 is provided.

The angle α and the lateral spacing a are matched relative to one another such that the guard fingers 9, when loaded in a direction opposite to the vertical direction 28, can elastically deform in the downward direction by utilizing the flexibility of the support back 14 without reaching the area of the blade plane 6. After having traveled a corresponding spring travel, the edges 31 contact the support bar 15 so that suddenly a stiffness increase of the elastic system occurs. Further bending deformations in a direction opposite to the vertical direction 28 are possible only to a limited extent. In regard to other features and reference numerals, the embodiment of FIG. 6 is identical to that of FIG. 5.

While specific embodiments of the invention have been shown and described in detail to illustrate the inventive principles, it will be understood that the invention may be embodied otherwise without departing from such principles.

What is claimed is:

1. A cutter bar of a motor-operated hedge trimmer, the cutter bar comprising:
a blade support;
at least one cutter blade guided so as to slide oscillatingly on the blade support, wherein the at least one cutter blade has laterally projecting cutting teeth defining a blade plane;
a cutter guard mounted on the blade support and extending across at least a part of the at least one cutter blade, wherein the cutter guard has laterally projecting guard fingers covering the cutting teeth with oversize;
wherein the cutter guard is comprised of an impact-resistant plastic material.

2. The cutter bar according to claim 1, wherein the cutter guard has a longitudinal support extending in a longitudinal direction of the blade support, wherein the guard fingers are attached to the longitudinal support, wherein the guard fingers are more bending resistant than the longitudinal support in a deformation plane that is perpendicular to the blade plane and to the longitudinal direction.

3. The cutter bar according to claim 2, wherein the guard fingers and the longitudinal support form a monolithic part.

4. The cutter bar according to claim 2, wherein the longitudinal support has a U-shaped cross-section comprising a first lateral flank, a second lateral flank, and a flexible support back connecting the first and second lateral flanks.

5. The cutter bar according to claim 4, wherein the blade support comprises a support bar, wherein the U-shaped cross-section of the longitudinal support encloses the support bar of the blade support, wherein the support back of the cutter guard is fastened on the support bar, and wherein the first and second lateral flanks loosely contact the support bar, respectively.

6. The cutter bar according to claim 5, wherein play is provided between the first and second lateral flanks and the support bar, respectively.

7. The cutter bar according to claim 1, wherein the guard fingers each have a finger base and a fingertip, wherein the guard fingers, starting at the finger base, have an increasing spacing relative to the blade plane in a direction toward the fingertip, respectively.

8. The cutter bar according to claim 1, wherein the guard fingers each have a finger base and a fingertip, wherein the guard fingers, starting at the fingertip, have a height increasing in a direction toward the finger base in a deformation plane that is perpendicular to the blade plane and to the longitudinal direction.

9. The cutter bar according to claim 8, wherein the height of the guard fingers at the finger base adjoining the longitudinal support matches a height of the longitudinal support.

10. The cutter bar according to claim 8, wherein the guard fingers, starting at the fingertip, have an increasing width in the blade plane in a direction toward the finger base, respectively.

11. The cutter bar according to claim 1, wherein the guard fingers have reinforcement ribs.

12. The cutter bar according to claim 11, wherein the reinforcement ribs are connected to the longitudinal support.

13. The cutter bar according to claim 10, wherein the reinforcement ribs widen in a fan shape.

14. The cutter bar according to claim 13, wherein the guard fingers each have a finger base and a fingertip, wherein the reinforcement ribs widen in a fan shape form the fingertip in a direction toward the finger base, respectively.

15. The cutter bar according to claim 11, wherein the guard fingers that neighbor one another are connected to one another by at least one of the reinforcement ribs that is common to the neighboring guard fingers, respectively.

16. The cutter bar according to claim 15, wherein the at least one reinforcement rib that is common to the neighboring guard fingers is arc-shaped.

17. The cutter bar according to claim 11, wherein the reinforcement ribs are arranged on a side of the guard fingers facing away from the at least one cutter blade.

18. The cutter bar according to claim 1, wherein the cutter guard has metal inserts adapted to receive fasteners.

19. The cutter bar according to claim 18, wherein the metal inserts are grommet-shaped and penetrate a support back of the cutter guard.

20. The cutter bar according to claim 1, wherein a first spacing between the guard fingers that neighbor one another is greater than a second spacing between the cutting teeth that neighbor one another.

21. The cutter bar according to claim 20, wherein the first spacing is approximately 1.5 times greater than the second spacing.

22. The cutter bar according to claim 1, wherein the cutter guard has a longitudinal support extending in a longitudinal direction of the blade support and having a free end provided with a slant that ascends away from the blade support.
